(19) United States
(12) Patent Application Publication
(10) Pub. No.: US 2015/0217297 A1
(43) Pub. Date: Aug. 6, 2015

(54) Hammer wheel mechanism capable of adjusting grinding force for annular roller type upright mill

(71) Applicant: HUNAN ZHONGHONG HEAVY MACHINERY CO., LTD., Shaoshan, Hunan (CN)

(72) Inventors: Zishun Sun, Shaoshan (CN); Hongzhong Sun, Shaoshan (CN)

(21) Appl. No.: 14/421,987

(22) PCT Filed: Aug. 16, 2013
(86) PCT No.: PCT/CN2013/081658

§ 371 Date: Feb. 16, 2015

(30) Foreign Application Priority Data
Aug. 17, 2012 (CN) 201210294386.2

(51) Int. Cl. B02C 15/08

(52) U.S. Cl. CPC B02C 15/08

(57) ABSTRACT

A hammer wheel mechanism capable of adjusting the grinding force of an annular type upright mill is provided, wherein a swinging arm is provided on a stelliform support via a swinging arm shaft, a hammer wheel is provided on a first end of the swing arm via a hammer wheel shaft, and a counterweight is provided on the swinging arm via an adjuster bolt. The present invention has beneficial effects as follows. The counterweight capable of moving transversely along the swinging arm is provided on a second end of the swinging arm of the hammer wheel. When the machinery is operating, the counterweight generates an inert centrifugal force simultaneously. According to the principle of the plane force system, a balancing torque is generated on a fulcrum. Adjusting corresponding position of the counterweight or changing the weight of the counterweight itself is capable of setting or adjusting the grinding force of the hammer wheel, so as to achieve an optimal effect, in such a manner that the machinery is capable of effectively grinding materials, the quality of the product is improves and production efficiency of the machinery is improved.

### CROSS REFERENCE OF RELATED APPLICATION

This is a U.S. National Stage under 35 U.S.0 371 of the International Application PCT/CN2013/081658, filed Aug. 16, 2013, which claims priority under 35 U.S.C. 119(a-d) to CN 201210294386.2, filed Aug. 17, 2012.

### BACKGROUND OF THE PRESENT INVENTION

1. Field of Invention The present invention relates to a hammer wheel mechanism capable of adjusting grinding force for an annular roller type upright mill.

2. Description of Related Arts

The conventional annular type rollers including the floating roller mill, the vertical planetary mill, the air swept annular mill, the swing roller mill and the centrifugal hoop mill all grind for crushing materials dropped from the top portion of the rolling ring under the centrifugal inertial force via the hammer wheel. If the weight of the hammer wheel is given, the grinding force of the hammer wheel increases with the improvement of the operating speed of the machine, so the machine critical state of the rotating speed of the machine is difficult to achieve. When the grinding force is excessive, for instance, over the required applying force under a limit of the crushing strength of the materials, it is easy to cause over grinding, so that the quality of the products is decreased. In addition, when the grinding force is not capable of reaching the strength of crushing the materials, the working efficiency is significantly reduced.

### SUMMARY OF THE PRESENT INVENTION

An object of the present invention is to provide a mechanism for adjusting the grinding force of a hammer wheel of an annular roller type upright mill, which is capable of effectively adjusting grinding force of the hammer wheel, so as to achieve adjusting crushing forces for meeting demands of materials having different hardness, and adjusting rushing forces for meeting demands of one kind of material in different grinding layers.

A technical solution of the present invention is as follows.

A hammer wheel mechanism capable of adjusting the grinding force of an annular type upright mill is provided, wherein a swinging arm is provided on a stelliform support via a swinging arm shaft, a hammer wheel is provided on a first end of the swing arm via a hammer wheel shaft, and a counterweight is provided on the swinging arm via an adjuster bolt.

A counterweight capable of moving transversely along the swinging arm is provided on a second end of the swinging arm of the hammer wheel. When the machinery is operating, the counterweight generates an inert centrifugal force simultaneously. According to the principle of the plane force system, a balancing torque is generated on a fulcrum. Adjusting corresponding position of the counterweight or changing the weight of the counterweight itself is capable of setting or adjusting the grinding force of the hammer wheel, so as to achieve an optimal effect, in such a manner that the machinery is capable of effectively grinding materials, the quality of the product is improves and production efficiency of the machinery is improved.

### BRIEF DESCRIPTION OF THE DRAWINGS

FIG. 1 is a sketch view of an installation structure of a hammer wheel capable of adjusting grinding force for an annular roller type upright mill according to a preferred embodiment of the present invention.

FIG. 2 is a partial enlarged view of A-A of the hammer wheel capable of adjusting grinding force for the annular roller type upright mill according to the preferred embodiment of the present invention.

### DETAILED DESCRIPTION OF THE PREFERRED EMBODIMENT

### Embodiment

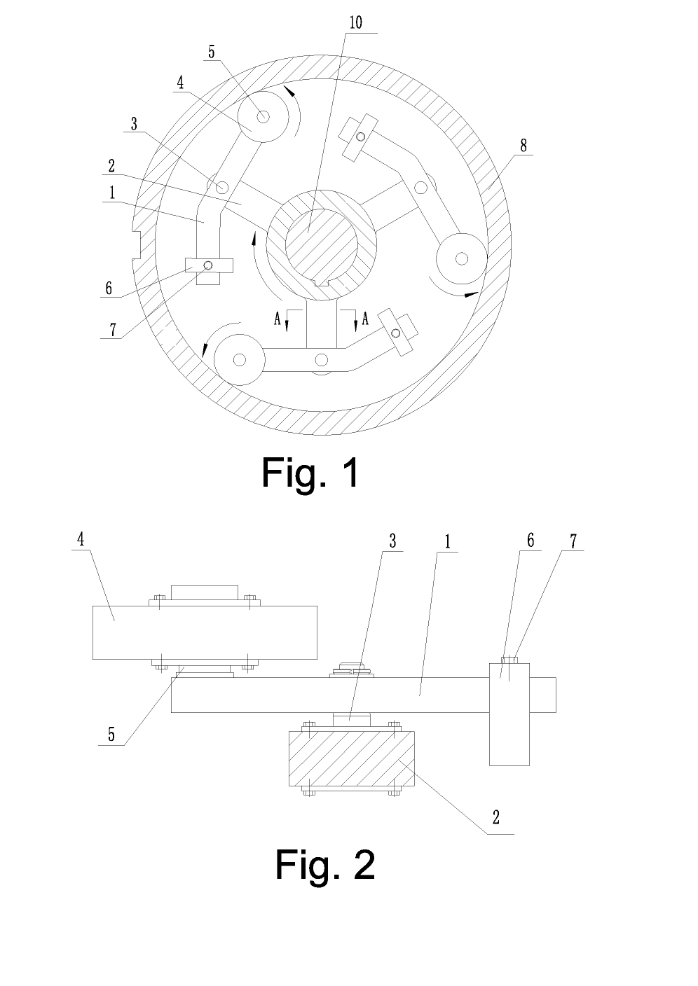

Referring to FIG. 1 and FIG. 2, a hammer wheel mechanism capable of adjusting the grinding force for an annular roller type upright mill is provided, wherein a stelliform support 2 is provided on a main shaft 10 of the annular roller type upright mill, a swinging arm 1 is provided on the stelliform support 2 via a swinging arm shaft 3, a hammer wheel 4 is provided on a first end of the swinging arm 1 via a hammer wheel shaft 5, a counterweight 6 is provided on the swinging arm 1 via an adjuster bolt 7, and the hammer wheel 4 rotates along an internal wall of a rolling ring 8.

What is claimed is:

1. A hammer wheel mechanism capable of adjusting grinding force for an annular roller type upright mill, wherein a swinging arm (1) is provided on a stelliform support (2) via a swinging arm shaft (3), a hammer wheel (4) is provided on a first end of the swinging arm (1) via a hammer wheel shaft (5), and a counterweight (6) is provided on the swinging arm (1) via an adjuster bolt (7).
